(19) United States
(12) Patent Application Publication
(10) Pub. No.: US 2015/0166350 A1
(43) Pub. Date: Jun. 18, 2015

(54) METHOD AND APPARATUS FOR FORMING SOLID CARBON DIOXIDE

(71) Applicant: Cold Jet, LLC, Loveland, OH (US)

(72) Inventors: David Stuart Fritz, Cincinnati, OH (US); Scott Thomas Hardoerfer, Milford, OH (US); Daniel Mallaley, Cincinnati, OH (US); Michael Eric Rivir, Cincinnati, OH (US)

(21) Appl. No.: 14/516,125

(22) Filed: Oct. 16, 2014

Related U.S. Application Data
(60) Provisional application No. 61/891,882, filed on Oct. 16, 2013.

(51) Int. Cl. C01B 31/22; B30B 11/04; B30B 15/30

(52) U.S. Cl. CPC C01B 31/22; B30B 15/302; B30B 11/04

(57) ABSTRACT

Liquid carbon dioxide is transformed into solid snow and compressed into strands. A shroud defines an insulating plenum/volume surrounding a forming chamber, which reduces heat transfer to the forming chamber. A faction of gas phase flow resulting from the process fills the insulating plenum/volume, reducing heat transfer further.

### RELATED APPLICATIONS

The present application claims the benefit of priority to U.S. Provisional Application No. 61/891,882, titled “Method And Apparatus For Forming Solid Carbon Dioxide” filed Oct. 16, 2013, the entire contents of which are hereby incorporated by reference.

### TECHNICAL FIELD

The present innovation relates to transforming liquid cryogenic material into solid cryogenic material, and is particularly directed to a method and apparatus for forming solid carbon dioxide from liquid.

### BACKGROUND

Carbon dioxide systems, such as for creating solid carbon dioxide particles, are well known, and along with various associated component parts, are shown in U.S. Pat. Nos. 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,695,679, and 6,824,450, all of which are incorporated herein by reference. Additionally, U.S. Patent Provisional Application Ser. No. 61/394,688 filed Oct. 19, 2010, for METHOD AND APPARATUS FOR FORMING CARBON DIOXIDE PARTICLES INTO BLOCKS, U.S. patent application Ser. No. 13/276,937, filed Oct. 19, 2011, for METHOD AND APPARATUS FOR FORMING CARBON DIOXIDE PARTICLES INTO BLOCKS, U.S. Patent Provisional Application Ser. No. 61/487,837 filed May 19, 2011, for METHOD AND APPARATUS FOR FORMING CARBON DIOXIDE PARTICLES, U.S. Patent Provisional Application Ser. No. 61/589,551 filed Jan. 23, 2012, for METHOD AND APPARATUS FOR SIZING CARBON DIOXIDE PARTICLES, U.S. Patent Provisional Application Ser. No. 61/592,313 filed Jan. 30, 2012, for METHOD AND APPARATUS FOR DISPENSING CARBON DIOXIDE PARTICLES, U.S. Patent Provisional Application Ser. No. 61/717,818, filed Oct. 24, 2012, for Jan. 30, 2012, for APPARATUS INCLUDING AT LEAST AN IMPELLER OR DIVERTER AND FOR DISPENSING CARBON DIOXIDE PARTICLES AND METHOD OF USE, U.S. Patent Provisional Application Ser. No. 61/594,347 filed Feb. 2, 2012, for APPARATUS AND METHOD FOR HIGH FLOW PARTICLE BLASTING WITHOUT STORAGE, U.S. Patent Provisional Application Ser. No. 61/608,639 filed Mar. 8, 2012, for APPARATUS AND METHOD FOR HIGH FLOW PARTICLE BLASTING WITHOUT STORAGE, and U.S. patent application Ser. No. 13/757,133 filed Feb. 1, 2013, for APPARATUS AND METHOD FOR HIGH FLOW PARTICLE BLASTING WITHOUT STORAGE are hereby incorporated by reference.

Although this patent refers specifically to carbon dioxide in explaining the innovation, the innovation is not limited to carbon dioxide but rather may be applied to any suitable cryogenic material. Thus, references to carbon dioxide herein are not to be limited to carbon dioxide but are to be read to include any suitable cryogenic material.

Solid cryogenic material, such as solid carbon dioxide, may be formed by many ways. s many uses. Such solid particles may be formed by transforming liquid carbon dioxide into small solid particles (“snow”) via phase change, and forming that snow into strands of solid carbon dioxide by forcing the snow through die openings. The strands may be cut or broken into short pieces, forming pellets. As a result of this process, in getting from liquid carbon dioxide to strands of solid carbon dioxide, a faction of the carbon dioxide changes to the gas phase. Most of this gas phase transformation occurs during the formation of the solid phase as snow.

The yield from and efficiency of this process may be affected by many things, such as the pressure at which the process is carried out, the backpressure downstream of the phase change, the flow rate, heat transfer, etc. Included among the many aspects of the present innovation is venting of byproduct gas phase material which reduces backpressure within the chamber within which the snow is formed and reduced heat transfer thereto.

### BRIEF DESCRIPTION OF THE DRAWINGS

The accompanying drawings, which are incorporated in and constitute a part of this specification, illustrate embodiments, and, together with the general description of the invention given above, and the detailed description of the embodiments given below, serve to explain the principles of the present innovation.

FIG. 1 is a right front-side perspective view of a system for forming solid carbon dioxide material constructed in accordance with the teachings of the present disclosure;

FIGS. 2 and 3 are a right-front perspective view of a forming subassembly of the system of FIG. 1 which includes a driving cylinder, the forming chamber with the shroud omitted, and a chill down assembly;

FIG. 4 is similar to FIGS. 2 & 3, illustrating the forming chamber in cross-section;

FIG. 5 is a perspective view of an alternate embodiment illustrating a heat exchanger adjacent the forming chamber; and

FIG. 6 is an exploded perspective view of the vent screens of the system of FIG. 1.

Reference will now be made to one or more embodiments illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations.

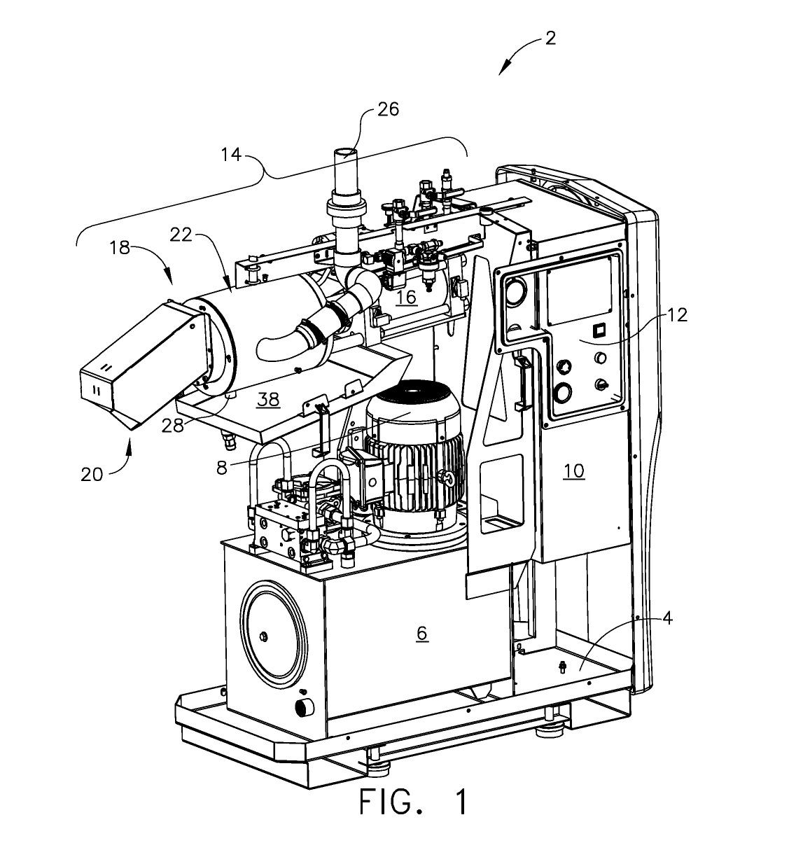

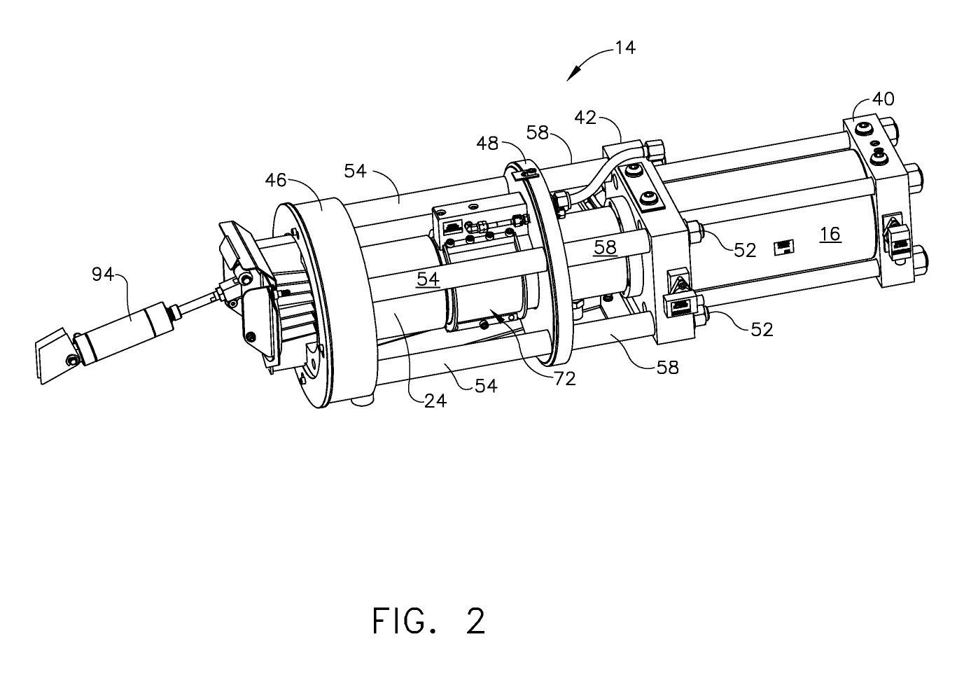

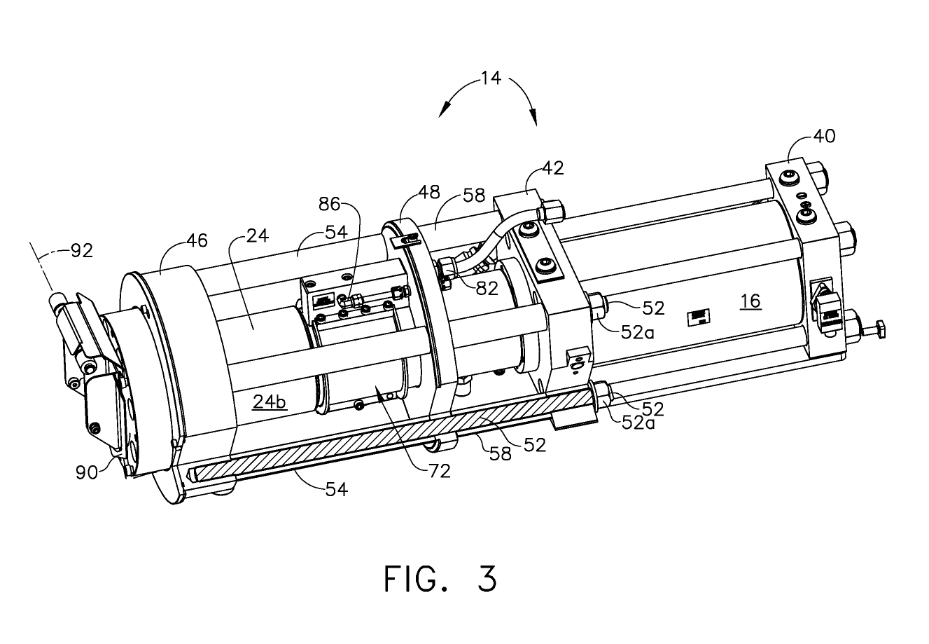

Referring to FIG. 1, there is shown a system, generally indicated at 2, which transform liquid carbon dioxide into strands of solid which may be broken or cut into shorter sections or pellets. It is noted that an apparatus for breaking or cutting the strands is not illustrated in FIG. 1. In the embodiment depicted, system 2 includes a frame, generally indicated at 4, which supports hydraulic reservoir 6, motor/pump 8 and enclosure 10 which contains the controls and control panel 12. Forming subassembly 14 is also carried by frame, and includes hydraulic cylinder 16, forming chamber assembly 18 and chill down/exit assembly 20. Visible in FIG. 1, forming chamber assembly 18 includes shroud 22 which defines an insulating plenum/volume surrounding forming chamber 24 (see FIGS. 2-4). The interior of shroud 22 is in fluid communication with vent 26, by which the byproduct factional gas phase flow is vented from the interior of shroud 22. Optionally, vent 26 may have a reduced pressure to pull byproduct factional gas from the interior of shroud 22.

Shroud 22 may also include vent 28 located at a low spot of shroud 22 for permitting any condensate or other liquid within shroud 22 to drain therefrom onto drip pan 30. Drip pan 30 may be plumbed to an external drain.

Referring to FIGS. 2-4, forming subassembly is illustrated. In the embodiment depicted, forming chamber 24 is a cylinder which defines interior volume 32. Chamber 24 includes first end 34 which is piloted about cylinder adaptor 36, which is secured to hydraulic end plate 38. Hydraulic cylinder 16 is of conventional construction, with hydraulic end plate 38 being secured to hydraulic end plate 40 by tie rods 42.

Chamber 24 includes second end 44 which is stepped and piloted with a complementarily shaped stepped bore in end plate 46. Intermediate first end 34 and second end 44 is bulkhead plate 48 having a bore through which chamber 24 is disposed. Seal 50 may be disposed in an annular groove formed in the bore.

Forming chamber assembly 18 is held together and to hydraulic cylinder 16 by a plurality of tie rods 52. A first plurality of spacers 54 maintain end plate 46 and plate 48 in a spaced apart relationship which is defined by spacers 54, and a second plurality of spacers 58 maintain plate 48 and hydraulic end plate 42 in a spaced apart relationship which is defined by spacers 58. Tie rods 52 are secured at one end to end plate 46, by threaded engagement with blind holes in the embodiment depicted, and captively retain forming chamber assembly 18 together to hydraulic end plate 42 by nut 52a. The piloted diameters, spacers and tie rods provide proper alignment and oppositional forces to the urging of carbon dioxide through the die plate (described below).

Disposed for axial reciprocating movement within forming chamber 24 is piston 60, connected to hydraulic rod 62 of hydraulic chamber 16. One or more seal band 64 is provided to form a seal between piston 60 and internal surface 24a of forming chamber 24.

End plate 46 carries die plate 66 with a plurality of die openings 66a, which is backed by backing plate 68 which maintaining the structure of relatively thin die plate 66 against the forces exerted on die plate 66 by piston 60 through a cake of solid carbon dioxide formed from the snow.

Forming chamber 24 includes a plurality of vents 70 formed through the wall of forming chamber 24. Vents 70 are covered at exterior surface 24b of forming chamber 24 by screen assemblies 72, preventing snow from flowing therethrough while allowing the byproduct gas to flow thereout.

Shroud 22 is piloted at one end by plate 48 with a step and at the other end by end plate 46 with, for example, 0.010 to 0.020 clearance to provide a slight slip fit, and sealed therebetween by any suitable sealing material such as Teflon® tape. Shroud 22 is held at plate 46 by retaining plate 84, which is secured to plate 46 in any suitable manner, such as through a plurality of fasteners 86 extending through keyway holes 88. A seal is provided between shroud 22 and plate 46, with any suitable material and manner such as through Teflon® tape. Additionally, a seal may be provided between retaining plate 84 and plate 46, through any suitable material manner such as through Teflon® tape. Shroud 22 thus defines insulating plenum/volume 74 which retains any exhausted gas adjacent forming chamber 24. The plenum volume 74 forms an insulating chamber around forming chamber 24 which is filled with low temperature exhaust gas, thereby reducing heat transfer to forming chamber 24.

Injection manifold 76 is secured to exterior surface 24b, and includes internal port 78 which places source of liquid carbon dioxide 80 in selective fluid communication with interior volume 32. In the embodiment depicted, 80 is depicted as a tube which engages fitting 82 and extends through plate 48 into port 78. Tube 80 may be selectively connected to a source of liquid carbon dioxide with a valve (not shown) in the line. Alternately, an actual phase change nozzle may be provided for injection of liquid carbon dioxide into interior 32 under conditions that result in the liquid changing phases to solid snow. As mentioned above, a faction of the liquid flow, and potentially a faction of the formed snow as it is compressed and recompressed into a dry ice cake by cyclical compression from the reciprocating movement of piston 60, becomes gas. The carbon dioxide in the gas phase may pass through vents 70, preferably in a manner which permits control of the backpressure within interior volume 32. Pressure sensing port 84 is in fluid communication with interior volume 32 and connected, through fitting and tubing 86 to an externally located pressure transducer. Internal pressure may be monitored as part of the control of the amount and pressure of liquid injected.

Carbon dioxide in the gas phase change is cold, and is held adjacent forming chamber 24 by shroud 22 within insulating plenum/volume 74. The annular plenum/volume 74 covers more than just vents 70 and a boundary thereabout, covering substantially the entirety of forming chambers 24, and in the depicted embodiment covers the entirety. This provides an insulating region, and when filled with cold exhausted, byproduct gas, further cools forming chamber 24. surrounding a forming chamber.

To form solid carbon dioxide, pressurized liquid carbon dioxide, at any suitable pressure is flashed to solid by being injected into interior chamber 32 through injection port 78, forming snow. After a sufficient amount of snow is present within interior chamber 32, piston 60 is advanced, urging the snow against die plate 66. During start up, the openings in backing plate 68 is occluded by moveable door 90, which in the embodiment depicted is pivotal about hinge axis 92 by selective actuation of cylinder 94. With door 90 sealing against the openings in backing plate 68, gas and snow cannot flow thereout. During the chill down cycle, snow may flash to gas as part of the process of reducing the temperature of forming assembly 18 to a steady state operating temperature. During this chill down cycle, the hydraulic pressure of hydraulic cylinder assembly is low until the thickness of the dry ice cake formed by repetitive cycles of piston 60 is sufficient to be urged against and resisted by die plate 66. When the hydraulic pressure exceeds a selectable predetermined amount, piston 66 may be cycled for an selectable predetermined number of additional cycles and door 90 opened thereafter, allowing production of strands of solid to begin formation and flowing out of die plate 66. A cutter or impeller (neither is shown) may be disposed downstream of die plate 66 and door 90 to cut or break the strands into short segments or pieces.

During operation of forming assembly 18, a slow flow of cold byproduct gas is collected and retained adjacent exterior surface 24b of forming chamber 24. Although heat from the ambient and from any component parts is absorbed by the gas raising its temperature, the resultant temperature remains significantly lower adjacent exterior surface 24b of forming chamber 24 than the ambient temperature, thereby reducing heat transferred to forming chamber 24. This improves the efficiency and yield of the process.

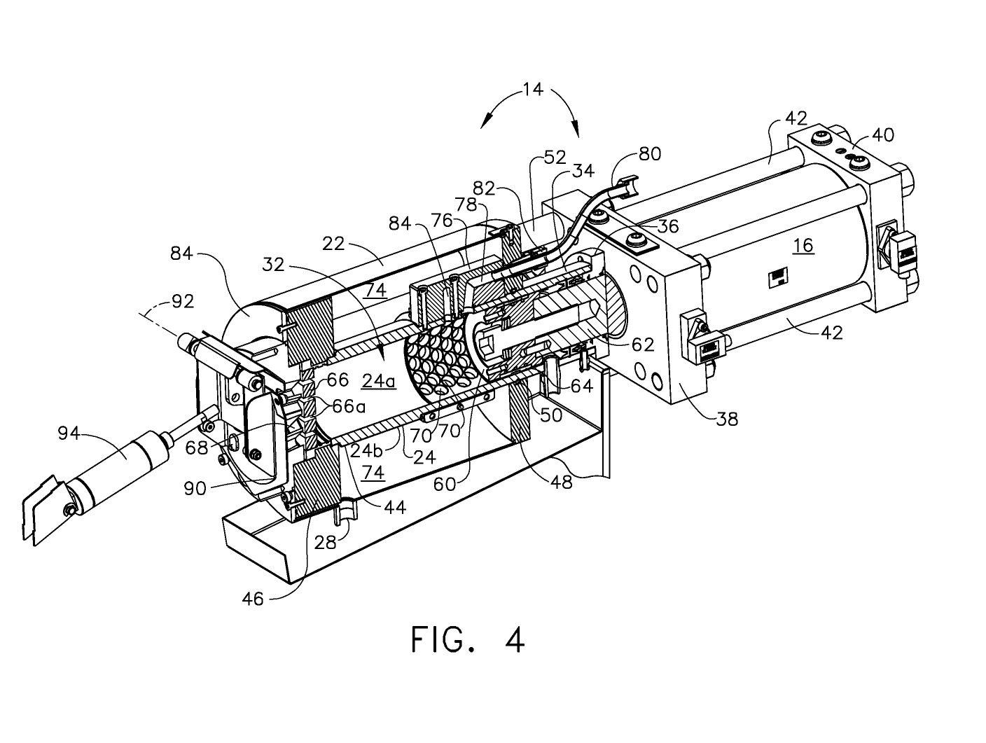

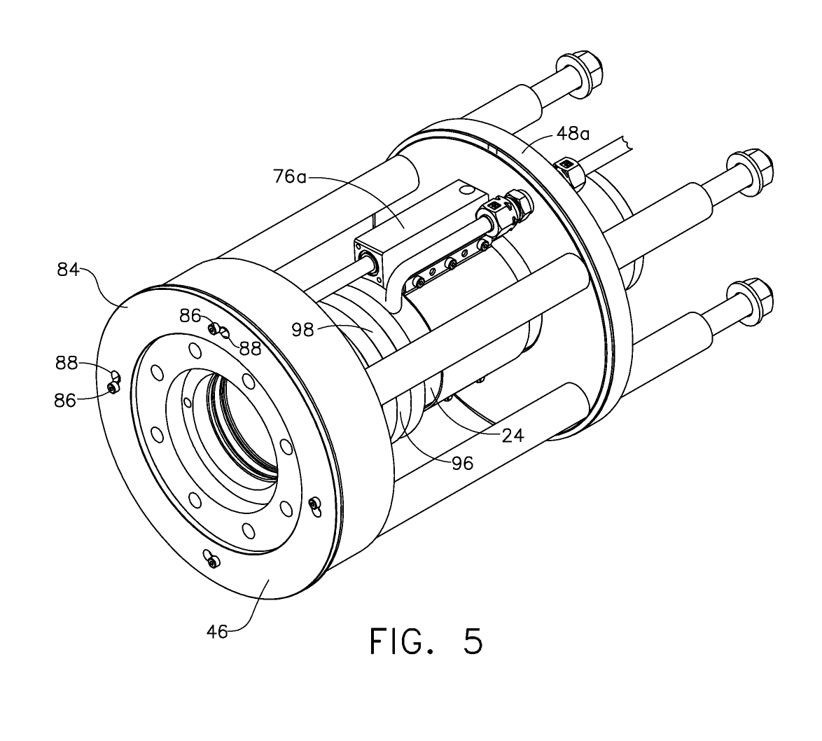

FIG. 4 illustrates an alternate embodiment in which heat exchanger 96 is disposed in a heat exchange relationship with forming chamber 24. FIG. 24 illustrates heat exchanger 96 as a coil which is connected to the source of liquid carbon dioxide. In the depicted embodiment, tube 98 provides a flow path from plate 48a, is coiled proximal outer surface 24b, in direct contact in the embodiment depicted, and to manifold 76a. Alternately, tube 78 could provide a flow path back out through plate 48a, with an tube to interior volume 74 providing a flow path back to a manifold constructed and disposed as illustrated above for manifold 76.

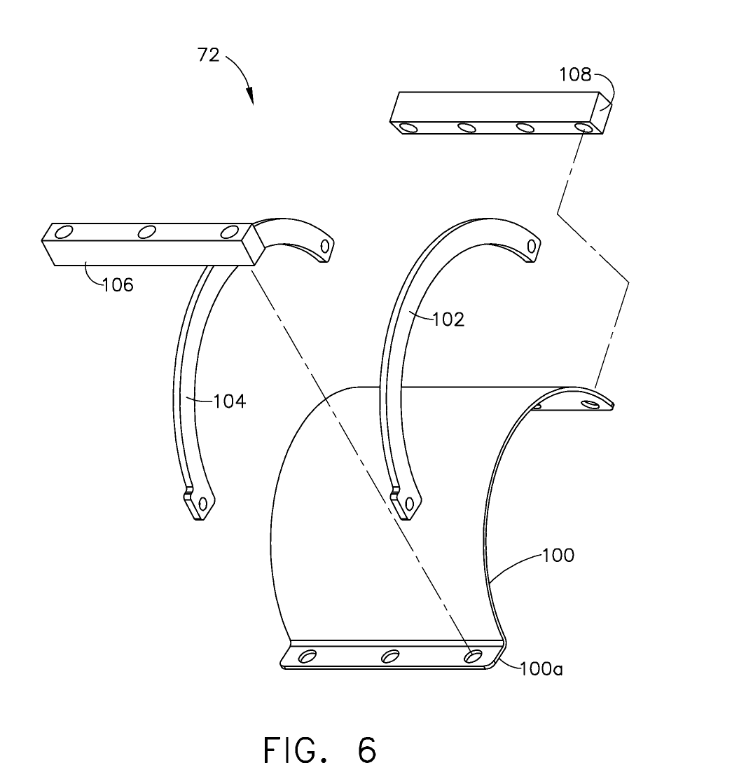

FIG. 6 illustrates one half of screen assembly 72, each half of which comprises screen 100 and two arcuate frame members 102 and 104 providing strength and retention in the radial direction. Mounting member 106 engages flange portion 100a which may be secured to the mating flange portion/mounting member of the other screen of screen assembly 72. End 100b may be secured directly to exterior surface 24b with mounting member 108. Screen 100 may be made of layers of screen material, such as perforated 304 stainless steel with 0.125 inch holes on 0.187 staggered centers, 0.03 inches thick and 40% open, 30/0.0110 wire, 304 SST wire cloth, 150/0.0026 wire, 304 SST wire cloth and 60/0.0065, 304 SST wire cloth. Screen assembly 72 may be sealed at it periphery to exterior surface 24b in any suitable manner.

The foregoing description has been presented for purposes of illustration and description. It is not intended to be exhaustive or to limit the invention to the precise form disclosed. Obvious modifications or variations are possible in light of the above teachings. The embodiment was chosen and described in order to illustrate the principles of the invention and its application to thereby enable one of ordinary skill in the art to utilize the invention in various embodiments and with various modifications as are suited to the particular use contemplated. Although only a limited number of embodiments of the invention is explained in detail, it is to be understood that the invention is not limited in its scope to the details of construction and arrangement of components set forth in the preceding description or illustrated in the drawings. The invention is capable of other embodiments and of being practiced or carried out in various ways. Also, specific terminology was used herein for the sake of clarity. It is to be understood that each specific term includes all technical equivalents which operate in a similar manner to accomplish a similar purpose. It is intended that the scope of the invention be defined by the claims submitted herewith.

1. A system configured to transform liquid cryogenic material into solid cryogenic material, the system comprising:
a. a forming chamber configured to receive particles of said cryogenic material, said forming chamber comprising:
i. a first end;
ii. a second end;
iii. an interior chamber; and
iv. an exterior surface;
b. a die plate carried by said second end, said die plate having at least one die opening;
c. a piston disposed in said internal chamber and moveable between a first position and a second position, said second position being closer to said die plate than said first position; and
d. an enclosed volume surrounding said forming chamber, said enclosed volume extending from a location adjacent said second end to at least a location adjacent said first position, said enclosed volume configured to hold gas phase cryogenic material adjacent said exterior surface of said forming chamber.

2. The system of claim 1, wherein said first end is adjacent said first location.

3. The system of claim 1, wherein said enclosed volume is defined by:
a. a shroud disposed about and space from said exterior surface, said shroud having a first end and a second end;
b. a first plate disposed adjacent said first location, said first plate being in sealing engagement with said forming chamber and with said first end of said shroud; and
c. a second plate disposed adjacent said second location, said second plate being sealing engagement with said forming chamber and with said second end of said shroud.

4. The system of claim 3, comprising a vent, said enclosed volume being in fluid communication with said vent.

5. The system of claim 4, wherein said vent has a lower pressure than said enclosed volume.

6. The system of claim 3, comprising a plurality of tie rods, at least a respective portion of each tie rod of said plurality of tie rods disposed entirely within enclosed volume and extending between said first and second plates.

7. The system of claim 1, wherein said forming chamber comprises at least one vent extending between said interior chamber and said enclosed volume, said at least one vent being disposed between said first and second locations proximal said first location.

8. The system of claim 1, comprising an injection port configured to flash at least a faction of liquid cryogenic material to solid cryogenic material and disposed to inject said solid cryogenic material into said interior chamber.

9. A system configured to transform liquid cryogenic material into solid cryogenic material, the system comprising:
a. a forming chamber configured to receive particles of said cryogenic material, said forming chamber comprising an interior chamber and an exterior surface;
b. an injection port configured to flash at least a faction of liquid cryogenic material to solid cryogenic material and disposed to inject said solid cryogenic material into said interior chamber; and
c. a flow path configured to place said injection port in fluid communication with a source of liquid cryogenic material, at least a portion of said flow path disposed in a heat exchange relationship with said forming chamber.

10. The system of claim 9, wherein said at least a portion of said flow path comprises a heat exchanger, said heat exchanger being disposed adjacent a portion of said exterior surface.

11. The system of claim 9, comprising an enclosed volume surrounding at least a portion of said forming chamber, and wherein said at least a portion of said flow path is disposed within said enclosed volume.

12. The system of claim 9, comprising a shroud disposed about and spaced from said exterior surface, said shroud at least in part defining said enclosed volume.

13. The system of claim 12, wherein said shroud comprises a first end and a second end, and said system comprising first and second spaced apart plates plate, said first plate being in sealing engagement with said first end and said forming chamber and said second plate being in sealing engagement with said second end and said forming chamber.

14. The system of claim 13, wherein said enclosed volume is defined by said shroud, said first plate, said second plate and said forming chamber.

15. The system of claim 9, comprising a vent, said enclose volume being in fluid communication with said vent.
